(19) United States
(12) Patent Application Publication
(10) Pub. No.: US 2012/0251289 A1
(43) Pub. Date: Oct. 4, 2012

(54) Cargo Delivery System and Method

(76) Inventor: Thomas Gesuale, Kings Park, NY (US)

(21) Appl. No.: 13/349,064

(22) Filed: Jan. 12, 2012

Related U.S. Application Data
(63) Continuation-in-part of application No. 12/653,210, filed on Feb. 5, 2010, now abandoned.

(51) Int. Cl. B60P 3/07; B65G 65/00

(52) U.S. Cl. 414/800; 410/4

(57) ABSTRACT

Disclosed is an improved system and method for delivering and backhauling cargo to and from a destination. The present invention generally comprises a first and second truck that are in an outbound configuration to deliver a cargo to at least one location. The first and second truck each have at least one flatbed section. After the cargo has been delivered, the first and second truck assume a return configuration wherein the second truck and second truck flatbed is stored on and secured to the at least one flatbed section of the first truck for a backhaul destination for the second truck. It is important to note that no portion of the second truck and second truck flatbed section in the return configuration is in contact with the ground, they are only in contact with the first truck flatbed section.

This application is a continuation-in-part of co-pending U.S. Application Ser. No. 12/653,210, filed on Feb. 5, 2010, the disclosures of which are hereby incorporated by reference.

### FIELD OF THE INVENTION

The present invention relates to an improved system and method for delivering cargo and backhauling to and from at least one location.

### BACKGROUND OF THE INVENTION

The increase in truck traffic on roadways is a growing concern that has led people such as politicians, city planners, and even trucking industry officials to acknowledge that a plan needs to be developed to reduce the number of trucks on the roadways or to at least reduce the rate that truck traffic is expected to increase in the coming. years. The effects that are associated with a high level of truck traffic are highly undesirable. They include an increase in the severity of automobile accidents, an increase in the amount of pollution introduced into the environment, and an increase in the costs needed to maintain the roadways.

It has been estimated by the New York Metropolitan Transportation Council that by 2030 the amount of trucked goods in Long Island, New York alone will go from 92 million to 173 million tons annually. The Long Island Expressway (“LIE”), the major east-west highway in Long Island, is expected to bear the brunt of the anticipated increase. Not too long ago, a tanker truck carrying gasoline exploded on the LIE, killing the driver and stopping eastbound traffic for approximately 24 hours.

In addition, with the current state of the economy and the increased budget restraints, it will be difficult to find enough money available to ensure that roads are able to withstand the heavy load from increased truck traffic. The present invention aims to alleviate and address the foregoing problems by providing an improved cargo delivery system and method that reduces the amount of truck traffic and that saves money. The present invention will also lead to a reduction in the greenhouse gas emissions since the amount of truck traffic would be reduced.

### OBJECTS OF THE INVENTION

It is an object of the invention to provide an improved cargo delivery system and method that is cost-efficient.

It is an object of the invention to provide an improved cargo delivery system and method that is time-effective.

It is another object of the invention to provide an improved cargo delivery system and method that reduces truck congestion on roadways and therefore prevents the occurrence of more serious accidents.

It is a further object of the invention to provide an improved cargo delivery system and method that has a beneficial effect on the environment by reducing the number of harmful truck emissions.

### SUMMARY OF THE INVENTION

The present invention generally relates to a system and method for delivering cargo to at least one location. The system and method includes an outbound delivery configuration, wherein the outbound delivery configuration includes a first truck and a second truck that each have a cargo loaded thereon for delivering to a location. The location may be a single location or a separate different location. Preferably the second location is in close proximity to the first location. The first truck and second truck each preferably include a tractor unit, a first flatbed section attached to the tractor unit, and a second flatbed section attached to the first flatbed section. The cargo to be delivered is secured to the first and second flatbed sections of the first and second trucks.

Once the cargo has been delivered, the first and second trucks are adapted for a backhaul configuration. The preferable backhaul configuration includes the first truck having a backhaul cargo secured to the first flatbed section of the first truck. The backhaul configuration also includes assembling the second truck into a return configuration and storing the return configuration of the second truck onto the second flatbed section of the first truck. The return configuration of the second truck includes the second truck second flatbed section being detached from the second truck first flatbed section and then being loaded and secured onto the top surface of the second truck first flatbed section. In this configuration it is important to note that the first flatbed section of the second truck is still attached to the second truck tractor unit. It is preferred that the first truck and second truck have first flatbed sections of the substantially the same size and second flatbed sections of substantially the same size and that the second flatbed sections of each truck are greater in length that the first flatbed sections. It is also preferred that the second flatbed section of the second truck is collapsible so that a portion of the second flatbed section's length can be folded onto itself to reduce the size of the second flatbed section for a better fit on the surface of the second truck's first flatbed section. Rather than a foldable adjustment, the second flatbed section of the second truck may be adapted to have its size manipulated telescopically or by other means used in the art. All or some of the flatbed sections may be differently sized, such as longer or shorter and/or wider or narrower, in other embodiments.

Before the first truck returns to its final destination, the first truck returns the backhaul cargo and the second truck to their respective final destinations. In different embodiments the destination may be the same or different for all three units, or the destination may be the same for any two of the three units. It is preferred that the destinations are in close proximity if the destinations are different.

In an alternate embodiment, the first and second truck of the present invention may comprise one flatbed section and the backhaul configuration may include the second truck and second truck flatbed section being placed on and secured to the first truck flatbed section for a backhaul to at least one location. In this embodiment, the flatbed section of the first truck may be substantially the same size or may be longer or shorter and/or wider or narrower than the flatbed section of the second truck and there may be an overhang of at least a portion of the second truck over the first truck flatbed section. In a further embodiment the flatbed section of the second truck may be collapsible so that a portion of the second truck flatbed section can be folded onto itself to reduce the size of the flatbed section for a better fit onto the flatbed section of the first truck. The collapsible portion of the second truck flatbed section may be used to narrow or shorten the flatbed section. Rather than being collapsible, the size adjustment may be by telescopic or other means used in the art.

In an even further embodiment, the flatbed section of the first truck may be adjustable to widen or lengthen its size by having sections that may be unfolded or by having sections that may be telescopically manipulated. Other size adjustment means used in the art may alternatively be employed.

In a further alternate embodiment of the present invention, the cargo delivery and backhaul system may include only one truck that has two flatbed sections. After the one truck has delivered cargo to at least one location, the truck may be assembled into a backhaul configuration. The backhaul configuration in this embodiment is analogous to the return configuration of the second truck in the preferred embodiment of the present invention. In particular, the backhaul configuration comprises the second flatbed section of the one truck being detached from the first flatbed section of the one truck and placed on and secured to the first flatbed section of the one truck. The first flatbed section in this embodiment may be substantially the same size or may be longer or shorter and/or wider or narrower than the second flatbed section which may result in an overhang of at least a portion of the second flatbed section over the first flatbed section. Means, as discussed above in other embodiments, may be used to manipulate the dimensions of the first and/or second flatbed sections.

In a further embodiment of where the system includes one truck, the one truck may have more than two flatbed sections and the one truck may haul at least one cargo to at least one location. When the truck is finished with its delivery, the truck may be assembled into a backhaul configuration wherein the second and third or more flatbed sections may be stored on the first flatbed section of the truck or where the third or more flatbed sections may be stored on the first and/or second and/or third or more flatbed sections of the truck. The dimensions of the flatbed sections may be adapted to be sizably adjusted by the means that have been described herein.

The cargo delivery system and method may also include in other embodiments a first track that has one flatbed section and a second truck that has two flatbed sections. In this embodiment, the second truck may be assembled into a return configuration which is analogous to the return configuration of the preferred embodiment of the present invention. The return configuration may be stored on the flatbed section of the first truck for a backhaul to at least one location. All or some of the flatbed sections in this embodiment may be substantially the same size or some of the flatbed sections may be longer or shorter and/or wider or narrower than some of the other flatbed sections which may result in an overhang of at least a portion of the second truck over the first truck's flatbed section or an overhang of at least a portion of the second truck second flatbed section over the second truck first flatbed section. The flatbed sections in this embodiment may be adapted to be sizably adjusted by the means that have been described herein.

The present invention also contemplates an embodiment wherein the first truck may have at least one less or at least one more flatbed section than the second truck, wherein at least one flatbed section of the second truck may be stored on at least one other flatbed section of the second truck and the resulting configuration may be stored on the first truck flatbed sections. For example, the first truck may have two flatbed sections and the second truck may have three flatbed sections. The third flatbed section of the second truck may be detached and may be stored on the first and/or second flatbed section of the second truck. The second truck with the tractor unit, first flatbed section, and second flatbed section still attached may be stored on the first and second flatbed sections of the first truck. Alternatively, the second and third flatbed sections may be detached and may be stored on the first truck first and/or second flatbed section. All or some of the flatbed sections in this embodiment may be adapted to be sizably manipulated by the means that have been described herein.

### BRIEF DESCRIPTION OF THE DRAWINGS

FIG. 1A is a side view of a preferred embodiment of the first and second trucks of the present invention in an outbound configuration.

FIG. 1B is a side view of an alternate embodiment of the first and second trucks that are in a backhaul configuration.

FIG. 2 is a side view of the first truck having a first and second set of side panels and a first and second roof covering secured to its first flatbed section and its second flatbed section.

FIG. 3 is a side view of the chassis rails that may be used in connection with a hitch mechanism that may be used in the present invention.

### DETAILED DESCRIPTION OF THE INVENTION

The present invention relates generally to an improved cargo delivery and backhauling system and method that addresses the problem of many flatbed trucks delivering cargo to at least one location without having a cargo to backhaul. The system of the present invention allows for a first truck delivering a cargo to a destination to leave the destination with a second truck that is secured on at least a portion of the first truck's flatbed. The first truck then returns the second truck to its location of origin. As a result of the present invention's system, the environmental and health impact to communities will be significantly improved since fewer trucks will be on the road leading to fewer harmful emissions. In addition, the present invention will also reduce gas and driver expenses since there will be fewer trucks on the road.

The present invention has particular applicability in delivering waste containers to a final landfill disposal location and leaving from the disposal location with the first truck having a backhaul that includes a stack of waste containers secured to one flatbed section of the first truck and a disassembled second truck that is secured to another flatbed section of the first truck.

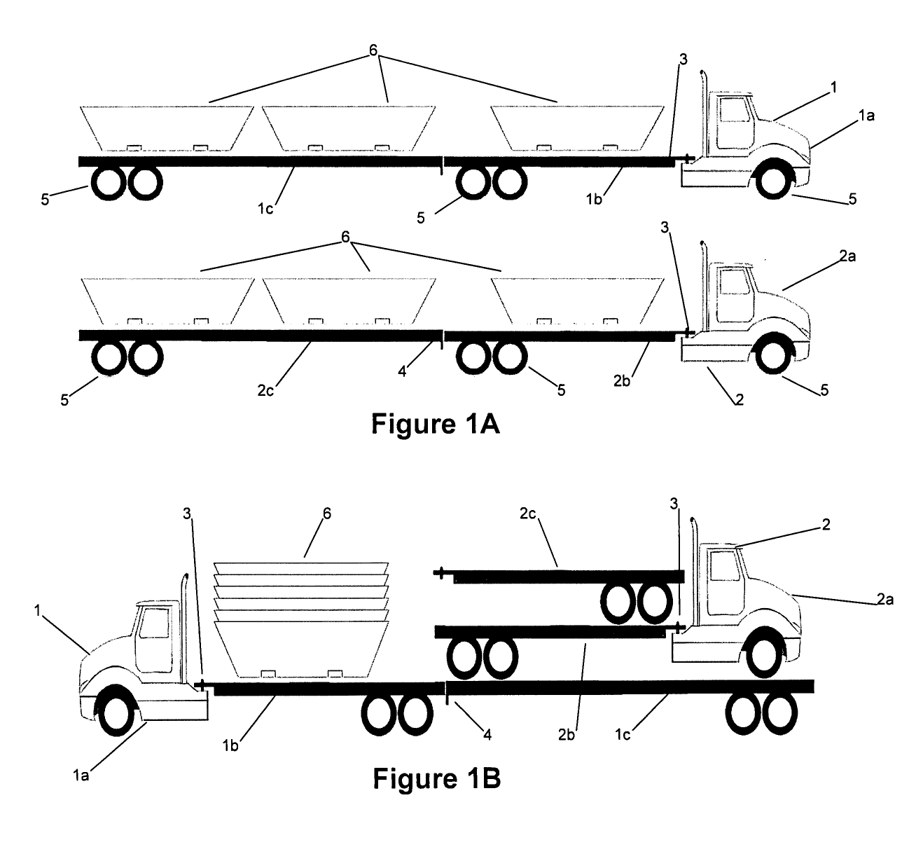

FIG. 1A represents a preferred embodiment of the present invention and shows a first 1 and a second 2 flatbed truck on an outbound delivery route for the final disposal of waste at a landfill location. The first 1 and second 2 trucks each contain a tractor unit 1a and 2a, a front flatbed portion 1b and 2b and a rear flatbed portion 1c and 2c. The tractor unit 1a and 2a and front flatbed portion 1b and 2b of each truck are preferably removably attached by a hitch mechanism 3 but some or all of the flatbed sections may be non-removably attached. The front flatbed portion 1b and 2b and rear flatbed portion 1c and 2c of each truck are also preferably removably attached by a hitch mechanism 4. The wheels 5 of each tractor unit and flatbed section of each truck are also visible. It is noted that in this embodiment, the first and second trucks are substantially the same. In particular, both of the first and second truck flatbed sections, tractor units, hitch mechanisms, and wheels are substantially the same in size, number, and design. Also of note in FIG. 1A is that the first flatbed section 1b and 2b of each of the first and second truck 1 and 2 is shorter in length than the second flatbed section 1c and 2c in each of the first and second truck 1 and 2.

FIG. 1A also shows the waste containers 6 that are secured on the flatbed portions 1b and 1c and 2b and 2c of the first 1 and second 2 truck. The waste containers are preferably suited to carry bulk freight including solid waste, liquid wastes, sludge, contaminated soils and ash. The waste containers are preferably Jezco Containers which are disclosed in U.S. Pat. No. 5,281,073, the disclosures of which are hereby incorporated by reference. The Jezco Container is generally a leak proof container that is constructed of steel and that may hold up to 8 tons of compacted waste without spilling or leaking waste liquids onto the roadways. In other embodiments, however, a different container may be used that is also leak proof but that may hold up to more than 8 tons or less than 8 tons of compacted waste. The containers may be constructed of steel, iron, aluminum, an alloy, etc.

As shown in FIG. 1A, the tractor unit, the first flatbed section, and the second flatbed section of each truck may have one set of wheels. However, it will be appreciated by those skilled in the art that the tractor unit, the first flatbed section, and/or the second flatbed section of the first and/or second truck may have more than one set of wheels.

The waste containers may be secured to the flatbed portions of the first and second trucks by having complimentary couplings on the bottom surface of the waste container and the top surface of the flatbed portions. For example, the bottom surface of the waste containers may have protrusions that are designed to mate with receptacles located along the top surface of the truck flatbed portions or vice versa. The couplings may have a hole through their length wherein the holes may be aligned when the couplings are mated so that a pin can be inserted through the holes to further secure the waste containers to the platform. Other regularly used means for securing a load to a flatbed trailer may also be utilized in the present invention's system, such as but not limited to straps in addition to or rather than the complimentary couplings described above.

The trucks that haul the waste containers are preferably 2 axle, medium duty, tractor trucks since these types of trucks would be less expensive and more fuel efficient than conventional heavy duty trucks, such as 3 or 4 axle tractor trucks. It will be appreciated by those skilled in the art, however, that trucks of 3, 4 or more axles may be used in the present invention.

FIG. 1B shows the first 1 and second 2 trucks of the present invention on a return route. It shows an alternate embodiment of the return configuration of the first 1 and second 2 trucks of FIG. 1A. The trucks in FIG. 1A are shown as both having a first flatbed section that is smaller than the second flatbed section. In FIG. 1B, the first flatbed section 1b and the second flatbed section 1c of the first truck are substantially the same dimensions as the first truck flatbed sections in FIG. 1A. The second truck, however, has a first flatbed section 2b that is substantially the same length as the second flatbed section 2c to allow the second flatbed section 2c to be stored on and secured to the second truck's first flatbed section without any overhang of the second flatbed section. The longer size of the first truck's second flatbed section 1e in this embodiment allows the second truck's tractor unit 2a and first flatbed section 2b to be stored on the first truck's second flatbed section without any overhang and with the second truck's tractor unit facing the rear of the first truck's second flatbed section as shown in FIG. 1B.

The return configuration of the present invention's system saves money and significantly reduces the harmful emissions that would otherwise be produced from two returning tractor trailer trucks. In FIG. 1B, the first truck's tractor unit 1a, first flatbed portion 1b, and second flatbed portion 1e are shown as hauling a stack of waste containers 6 and the second truck's tractor unit 2a, first flatbed portion 2b, and second flatbed portion 2c. The stack of waste containers 6 in FIG. 1B is shown as being secured to and stored on the first flatbed section 1b of the first truck 1 while the second truck is shown as being secured to and stored on the second flatbed section 1c of the first truck 1. It is important to note that in the present invention's system the whole of the second truck and the whole of the stack of waste containers are stored on the flatbed sections of the first truck and have no portion in contact with the ground. In particular the wheels of the second truck first flatbed section 2b and the wheels of the second truck tractor unit 2a are in contact with the top surface of the second flatbed section 1c of the first truck 1 while the wheels of the second truck's second flatbed section 2c are in contact with the second truck's first flatbed section 2b. In addition, the second truck 2 in FIG. 1B is shown as being stored on the second flatbed section is of the first truck 1 in a configuration where the tractor unit 2a of the second truck 2 is close to rear of the second flatbed section 1c. In addition, the second flatbed section 2c of the second truck 2 is shown as having its wheels close to the tractor unit 2a of the second truck 2 and its hitch mechanism 4 close to the wheels of the second truck's first flatbed section 2b. It is to be noted that in alternate embodiments, an 180° reversal of the second truck's configuration on the second flatbed section of the first truck in FIG. 1B can be used so that the wheels of the first flatbed section of the second truck and the hitch mechanism of the second truck's second flatbed section are close to the rear of the first truck's second flatbed section. In a further embodiment, the orientation of the tractor unit and first flatbed section of the second truck may remain as shown in FIG. 1B but the orientation of the second flatbed section of the second truck may be switched so that the hitch mechanism of the second flatbed section of the second truck resides by the tractor unit end of the first flatbed section of the second truck. In an even further embodiment, the tractor unit of the second truck may reside by the hitch point on the first truck's second flatbed section and the second truck's second flatbed section may be positioned so that its hitch point resides by the tractor unit end of the second truck's first flatbed section.

In the return configuration of FIG. 1A, the first flatbed section of each truck is shorter than the second flatbed section of each truck and each truck tractor unit is substantially the same size, shape and design. In this embodiment, the first flatbed section of each truck is preferably about 20 feet and the second flatbed section is preferably about 30 feet but they may be other lengths as long as the lengths do not depart from the spirit of this embodiment. When the second truck is disassembled to its return configuration, the second flatbed section is stored on the first flatbed section while the first flatbed section is connected to the tractor unit. There will be an overhang of at least a portion of the second flatbed section over the free end of the first flatbed section, i.e., the end of the first flatbed section that is not secured to the tractor unit, since the second flatbed section is longer than the first flatbed section. When the second truck in its return configuration is stored on the second flatbed section of the first truck, the tractor unit end of the second truck is by the hitch end of the first truck's second flatbed section to allow the overhang of the second truck's second flatbed section to extend beyond the rear end of the first truck's second flatbed section.

Alternatively, the first flatbed section in both the first and second truck may be larger than the second flatbed section in both the first and second truck. In this embodiment, the second truck may be transported on the first flatbed section and a portion of the second truck may extend to the second flatbed section where it will be secured. In different embodiments, the first flatbed sections of the first and second truck may be different sizes and the second flatbed sections of the first and second truck may also be different sizes. In further alternate embodiments, the first and second flatbed sections of the first truck may substantially be the same size and the first and second flatbed sections of the second truck may substantially be the same size. In even further alternate embodiments, the dimensions of the flatbed sections of the second truck may be different than the dimensions of the flatbed sections of the first truck. It will be appreciated by those skilled in the art that the various sizes of the flatbed sections of the first and second trucks may lead to an overhang portion in the storage of the second truck that is transported in its return configuration on the first truck; or the second truck in its return configuration may span a portion of more than one flatbed section of the first truck.

The stack of waste containers in FIG. 1B may be formed by depositing an empty waste container into the chamber of another empty waste container. The waste containers may be stacked as high as nine containers but a stack of less than nine or more than nine waste containers may alternatively be possible as long as the stack is stable and secure enough to withstand a haul. Each waste container in the stack may have complimentary couplings, such as male and female mating counterparts, to secure to a waste container that may be stacked below and/or stacked. The coupling may be a hook and eye coupling or a different coupling that is used in the art. Furthermore, securing cables or straps may be used in addition to or rather than the aforementioned stack couplings. The stack of waste containers may be built by a crane or other stack building means used in the art. In addition, the stack may be assembled before or after loading onto the flatbed section of the first truck. The preassembled stack of waste containers may be loaded onto the first truck's flatbed section by detaching the second flatbed section of the first truck from the first truck's first flatbed section. Once detached, the first flatbed section may be equipped with a flatbed tilting assembly so that the first flatbed section may be titled to an inclined loading position. The flatbed tilting assembly may comprise a shiftable axle shuttle which moves the flatbed axle(s) and wheels from one end of the flatbed to the other end. Other flatbed tilting mechanisms used in the art may alternatively be employed. In the embodiment with the flatbed tilting assembly, the bottom surface of the waste container stack may have removable or non-removable wheels so that the waste containers can be pushed or pulled onto the first flatbed section. A winch or other similar mechanism may be used to pull the stack of waste containers onto the first flatbed section. Alternatively, when a push mechanism is used, a plow or other similar pushing mechanism may be used to load the stack of waste containers. Alternatively, other stack loading mechanisms may be used, such as the assembled stack may be loaded onto the flatbed section by a crane, a forklift, etc.

In the embodiment where the stack is assembled on the flatbed section, the first container that forms the stack may similarly be loaded onto the flatbed section via a crane, forklift, plow, winch, or other cargo loading mechanism. Once the first waste container is loaded onto the flatbed section, the rest of the stack may be assembled by loading each waste container in a piecemeal fashion until the stack is completed. In this embodiment, each individual container may be loaded onto another container using a crane or other suitable loading mechanism.

Also of note in FIG. 1B, it is shown that the second truck tractor unit 2a, first flatbed section 2b, and second flatbed section 2c are stored and secured on the second flatbed section 1c of the first truck 1. The second flatbed section 2c of the second truck 2 is detached from and secured on the second truck's first flatbed section 2b in this embodiment. The collapsed configuration of the second truck 2 allows the first truck to haul a bigger load since the stack of waste containers 6 can be loaded onto the first truck's first flatbed section 1b and the second truck 2 can be loaded onto the first truck's second flatbed section 1e. In other embodiments, the stack of waste containers can be stored on the second flatbed section of the first truck while the second truck is stored on the first truck's flatbed section. In addition, more than one stack of waster containers may be hauled by the first truck rather than the first truck hauling a second truck. Alternatively, more than one truck may be hauled by the first truck rather than the first truck hauling a waste container. In even further embodiments, the first truck may be comprised of 3 or more flatbed sections wherein a second and third truck may be hauled in addition to the waste containers. Moreover, a second, third, and fourth truck may be hauled in this embodiment when the first truck is not hauling a stack of waste containers; or 3 or more waste containers may be hauled by the first truck when the first truck is not hauling any other trucks.

The second truck may be loaded onto the first truck by first disassembling the second truck and loading the second truck's second flatbed section onto the second truck's first flatbed section. The first flatbed section of the second truck may be equipped with a flatbed titling assembly, as described above, to receive the second flatbed section. A winch or other pulling mechanism used in the art may be utilized to load the second flatbed section onto the first flatbed section of the second truck. Alternatively, the second truck's second flatbed section may be pushed onto the first flatbed section of the second truck by a plow or other similar pushing mechanism. In an even further embodiment, a crane may be used to load the second flatbed section onto the second truck's first flatbed section. In this embodiment, the first flatbed section will preferably not be in an inclined position to receive the second flatbed section since the second flatbed section is being loaded by a crane or other similar loading mechanism.

The second flatbed section of the second truck may be secured to the first flatbed section of the second truck by a cable or wire that is wrapped around the second flatbed section and/or tires of the second flatbed section. The cable may be removably or non-removably attached to the first flatbed section of the second struck so that the second flatbed section is secured to the first flatbed section when the cable or wire is wrapped around the second flatbed section. The cable may be non-removably attached by means ordinarily used in the art such as but not limited to a being bolted onto the first flatbed section. The cable may be removably attached to the first flatbed section by a hook, clip or other removable attaching means used in the art. In another embodiment, the cable may be wrapped around the first flatbed section and/or tractor unit of the second truck in addition to being wrapped around the second flatbed section of the second truck. It will be appreciated by those skilled in the art that the second flatbed section of the second truck may be secured to the first flatbed section of the second truck by other means used in the art.

In a different embodiment of loading the disassembled second truck onto the second flatbed section of the first truck, the tractor unit and first flatbed section of the second truck may be loaded onto the first truck's second flatbed section before the second truck's second flatbed section is loaded onto the second truck's first flatbed section. In this embodiment, the second flatbed section of the first truck may be equipped with a flatbed tilting assembly as described above and the flatbed may be positioned in an inclined loading position. The second truck's tractor unit that is attached to the second truck's first flatbed section may then drive onto the second flatbed section of the first truck and be secured thereto by means that have been described in this application. The second flatbed section of the second truck may then be loaded onto the second truck's first flatbed section via a crane or other similar loading mechanism used in the art. The second flatbed section of the second truck may also be secured to the first flatbed section of the second truck by the means that have been discussed herein.

In one embodiment of the invention, the truck that is transported on the flatbed section of the transporting truck is the same type of truck. For example, the transporting truck and the transported truck may both be 2, 3, 4 or more axle trucks and may have the same number and/or size of wheels. In addition, the axles in the transporting truck and the axles in the transported truck may be of substantially the same size, width, length, and/or type. The flatbed sections of the transporting and transported truck may also be of substantially the same size and/or shape. Moreover, the tractor units of the transporting and transported truck may be substantially the same. In particular, the tractor units may be substantially the same type. For example, the tractor units may be a 4×2, 6×2, 6×4, 6×6, 8×6, 8×8, 10×8, 10×10 or other type of tractor unit.

In another embodiment of the present invention, the transporting truck and the transported truck may have differently sized axles as well as a different number of axles. The axles may be of a more heavy duty design and be more in number than the transporting truck or vice versa. The transporting truck may also have more or less wheels than the transported truck and the wheels of the transporting truck may be greater than or less than the size of the wheels in the transported truck. The tractor unit and/or flatbed trailer sections of the transporting truck may additionally be of a heavier duty or a lighter duty than the transported truck.

After the stack of waste containers 6 and the second truck 2 and second truck tractor unit 2a and flatbed sections 2b and 2c are secured, the first truck 1 embarks on the return delivery route with its trailer contents. In a preferred embodiment of the present invention the first truck 1, the stack of waste containers 6, and the second truck 2 have the same final destination. In other embodiments, however, the first truck 1, stack of waste containers 6, and/or second truck 2 may have different final destinations wherein the first truck 1 will drop off each respective load at its destination before the first truck 1 returns to its final destination.

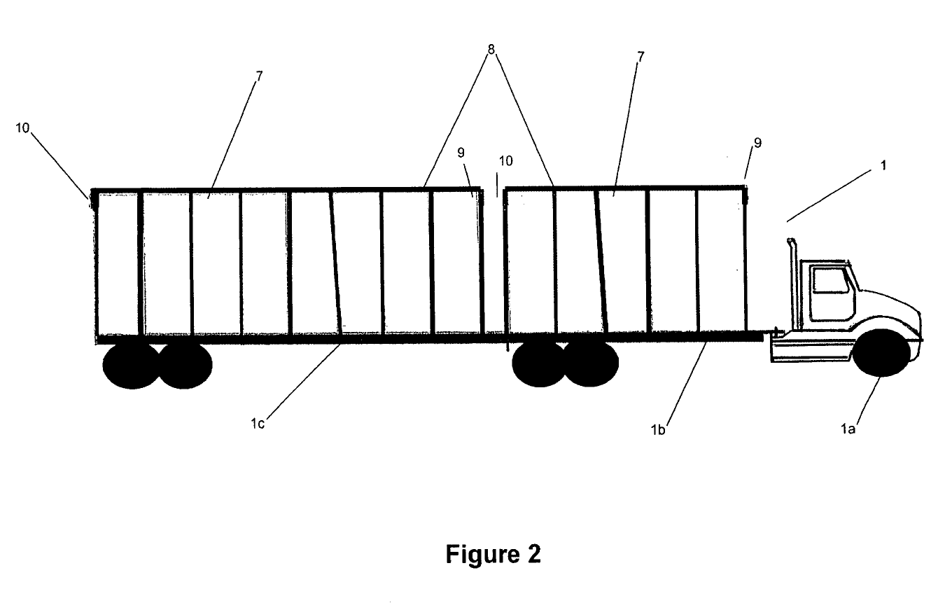

FIG. 2 provides an illustration of the first truck 1 having side panels 7 that are attached to the side surfaces of its first and second flatbed sections 1b and 1e. In this embodiment, the side panels 7 may be attached to the first truck flatbed sections 1b and 1e to provide further security to the stack of waste containers and the second truck and second truck flatbed sections that are secured thereon. Also shown in FIG. 2 is a roof covering 8 that may be placed over and cover the side panels 7 to cover and protect the contents on the flatbed sections 1b and 1c of the first truck 1. The roof covering 8 is also shown in FIG. 2 as extending over the front 9 and back 10 ends of the side panels 7 so that a portion of the front and back of the flatbed sections 1b and 1c are covered. The flatbed sections 1b and 1c may additionally contain back and/or front panels. The panels may be made from plywood, aluminum, fiberglass, or other materials used for panels in the trucking industry. A means for connecting the side panels to the trailer may also be included so that the side panels stand upright from their connection with the trailer. The connecting means may include but is not limited to complementary lock and fit means on the bottom surface of the side panels and the top surface of the trailer or other connecting means used in the art. In addition the roof covering may be a panel and may have a jigsaw, lock and fit, or other coupling means used in the art for coupling to the side panels. Alternatively, the roof covering may be a tarp that spans the length of the side panels and/or overlaps at least a portion of the front and back surfaces of the side panels. In other embodiments, other covering means used in the art may be used to cover the load.

In one embodiment, the side panels may be a Jezco side-panel kit wherein the panels may be made from plywood, aluminum, or fiberglass. The panels may be 3 feet wide and 8 feet high and may have two #4 wood posts on both ends of the panels that extend 4 inches below the bottom of the panels to fit inside complementary pockets on the trailers' top surface. In addition, the roof covering may be panels which may be 8 feet by 3 feet and may fit and lock onto the side panels to cover the cargo. The visible look of the trailer in this embodiment will be that of a closed van. In further embodiments the side panels may be other dimensions to correspond to the dimensions of the truck flatbed sections that the side panels are securing to and also to the size of the load, such as the height of the load, that is being covered and protected. The roof panels may also be different dimensions to correspond to the size of the side panels. The back and/or front panel may have dimensions to correspond to the dimensions of the side and/or roof panels.

The side panels in FIG. 2 are shown as attaching to the first and second flatbed sections separately to form two distinct compartments. Alternatively, however, the side panels may span the whole length of the combination of the first and second flatbed sections so that there is one compartment or the side panels may be configured to form 3 or more compartments depending on the cargo that the truck is transporting.

In the embodiments where there is an overhang over the back of the first truck, a back covering, such as a tarp, may be used rather than a back panel. The tarp may assume the shape of the overhang and may then be secured to the bottom of the rear of the flatbed section of the first truck.

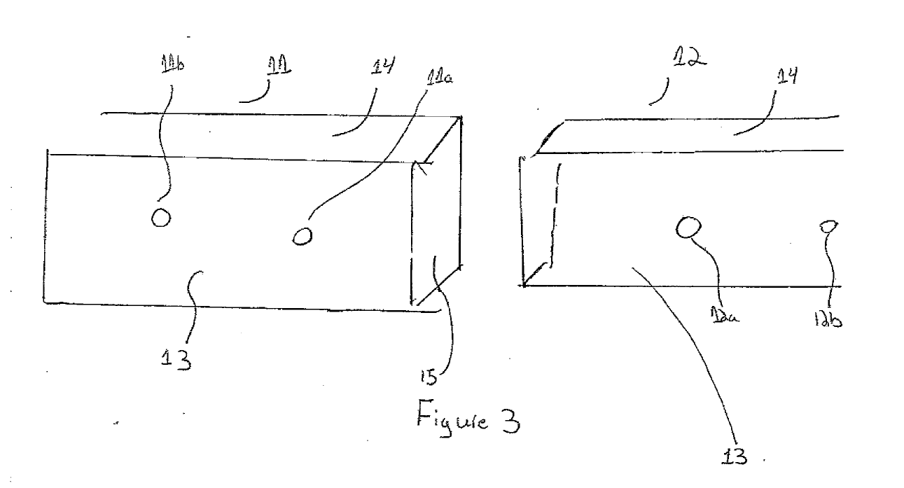

FIG. 3 is a representation of the hitch mechanism for connecting the truck to the trailer and the trailer sections to one another. FIG. 3 shows a first chassis rail 11 acting as a receiver hitch and a second chassis rail 12 that is inserted into the first chassis rail 11. Each chassis rail has a first side surface 13, a second side surface (not shown), a top surface 14, and a bottom surface (not shown) that preferably combine to form a hollow structure for the first and second chassis rail 11 and 12. There is also an opening 15 in the first chassis rail 11 to receive the second chassis rail 12. First chassis rail holes 11a and 11b and second chassis rail holes 12a and 12b are shown along the first side surface 13 of the first and second chassis rails 11 and 12. Holes (not shown) may also be preferably positioned along the second side surface of the first and second chassis rail 11 and 12. The holes on the first and second side surface of the first chassis rail and the first and second side surface of the second chassis rail are all preferably in direct alignment and along the same axial plane. The second chassis rail 12 has a slightly smaller diameter than the first chassis rail 11 to insert into the opening 15 of the first chassis rail 11 to a point where the holes along the first and second side surfaces of the first and second chassis rails are all in alignment so that a pin, a clip, or other securing instrument may be inserted through the holes to securely connect the first and second chassis rails. In one embodiment, the dimensions of the first chassis rail are such that a rectangular tube of 10 inches high by 4 inches wide is formed; and the dimensions of the second chassis rail are such that a slightly smaller rectangular tube of 9 ¾ inches high by 3 ¾ wide is formed.

An alternate embodiment of first and second chassis rails may be smaller than the first and second chassis rails of FIG. 3. In this embodiment, the dimensions of the first chassis rail may be 8 inches high by 4 inches wide while the second chassis rail dimensions may be 7 ¾ inches high by 3 ¾ inches wide. Other dimensions for the first and second rails may be used as long as the dimensions are sufficient to ensure a secure fit between the rails and a proper support between the tractor unit and flatbed sections. The chassis rails are preferably steel but may be comprised of any other metal, alloy, or other material used in the art. In addition, the chassis rails may be other shapes beside rectangular, such as but not limited to circular, square, or ovular.

The first chassis rail preferably acts as a receiver hitch to receive the second chassis rail wherein the second chassis rail is a ball mount that includes a removable or non-removable trailer ball. Alternatively, the second chassis rail may be a drawbar. Other hitch mechanisms may also be used and include but are not limited to a gooseneck hitch, a sliding or standard fifth wheel hitch, or other hitch mechanisms that are used for hauling a heavy load.

What is claimed is:

1. A system for delivering cargo to at least one location, comprising:
an outbound cargo delivery configuration, said outbound configuration including a first truck and a second truck that each have cargo to deliver to said location, said first truck and said second truck each having a tractor unit, a first flatbed section attached to said tractor unit, and a second flatbed section attached to said first flatbed section, said first flatbed section of said first and said second truck having a cargo secured thereon and said second flatbed section of said first truck and said second truck having a cargo secured thereon, said first flatbed section of said first and said second truck each having at least one pair of wheels attached to the bottom surface of each of said first and said second truck first flatbed sections, said second flatbed section of said first and said second truck each having at least one pair of wheels attached to the bottom surface of each of said first and said second truck section flatbed sections, said tractor unit of said first and said second truck each having at least one pair of wheels attached to the bottom surface of said first and said second truck tractor unit for driving said tractor unit;
a backhaul configuration, said backhaul configuration including said first truck having a backhaul cargo secured to said first truck first flatbed section and said second flatbed section of said first truck having a return configuration of said second truck secured thereon, said return configuration being said second truck first flatbed section attached to said second truck tractor unit while said second truck second flatbed section is stored and secured on the top surface of said second truck first flatbed section, wherein said wheels of said second truck second flatbed section are in contact with the top surface of said second truck first flatbed section in said return configuration and wherein said wheels of said second truck first flatbed section and said second truck tractor unit in contact with the top surface of said first truck second flatbed section when the disassembled return configuration of the second truck is secured on said first track second flatbed section.

2. The system according to claim 1 wherein said backhaul configuration includes a first set of side panels attached to said first flatbed section of said first truck to cover said backhaul cargo and a second set of side panels attached to said second flatbed section of said second truck to cover said return configuration of said second truck.

3. The system according to claim 2 wherein said backhaul configuration further comprises a first roof panel secured along the top edge of said first set of side panels and a second roof panel secured along the top edge of said second set of side panels, said first and said second roof panels covering the top of the backhaul configuration and the return configuration of the second truck.

4. The system according to claim 1 wherein said first truck cargo and said second truck cargo is at least one waste container, said waste container being a Jezco container.

5. The system according to claim 1 wherein said backhaul cargo is a stack of waste containers.

6. The system according to claim 1 wherein said second flatbed section of said first truck is longer than said first flatbed section of said first truck.

7. The system according to claim 6 wherein said first flatbed section of said second truck is substantially the same size as said second flatbed section of said second truck.

8. The system according to claim 7 wherein said first flatbed section of said second truck is substantially the same size as said first flatbed section of said first truck.

9. The system according to claim 1 wherein said first truck tractor unit and said second truck tractor unit are the same type.

10. The system according to claim 1 wherein said first truck and said second truck have axles of substantially the same size.

11. The system according to claim 1 wherein said first truck and said second truck have the same number of axles.

12. The system according to claim 11 wherein said first truck and said second truck are 2 axle medium duty trucks.

13. The system according to claim 11 wherein said first truck and said second truck are 3 axle heavy duty trucks.

14. The system according to claim 1 wherein said first truck and said second truck have the same number of wheels.

15. The system according to claim 14 wherein said wheels of said first truck and said wheels of said second truck are substantially the same size.

16. The system according to claim 1 wherein the attachment between the tractor unit and first flatbed section of the first and second trucks, and the attachment between the first flatbed section and the second flatbed section of the first and second trucks is a ball mount hitch mechanism.

17. The system according to claim 1 wherein said flatbed sections of said first and said second truck have a flatbed tilting assembly for receiving and loading said cargo to deliver, said backhaul cargo, and said second truck in said return configuration.

18. A system for delivering waste to a landfill, comprising:
an outbound waste delivery configuration, said outbound configuration including a first truck and a second truck that each have a cargo of waste to dispose of at said landfill, said first truck and said second truck each having a tractor unit, a first flatbed section hitched to said tractor unit, and a second flatbed section hitched to said first flatbed section, wherein said first truck cargo of waste includes one waste container secured to said first truck first flatbed section and two waste containers secured to said first truck second flatbed section, wherein said second truck cargo of waste includes one waste container secured to said second truck first flatbed section and two waste containers secured to said second truck second flatbed section, said first flatbed section of said first and said second truck each having at least one pair of wheels attached to the bottom surface of each of said first and said second truck first flatbed sections, said .second flatbed section of said first and said second truck each having at least one pair of wheels attached to the bottom surface of each of said first and said second truck section flatbed sections, said tractor unit of said first and said second truck each having at least one pair of wheels attached to the bottom surface of said first and said second truck tractor unit for driving said first and said second truck tractor unit;
a backhaul configuration for leaving said landfill after said first and said second trucks have delivered said cargoes of waste to said landfill, said backhaul configuration including said first truck having a stack of waste containers secured to said first truck first flatbed section and said second truck in a return configuration being secured to the top surface of said first truck second flatbed section, said second truck return configuration comprising said second truck first flatbed section attached to said second truck tractor unit and said second truck second flatbed section secured to the top surface of said second truck first flatbed section, wherein said wheels of said second truck second flatbed section are in contact with the top surface of said second truck first flatbed section in said return configuration and wherein said wheels of said second truck first flatbed section and said second truck tractor unit are in contact with the top surface of said first truck second flatbed section when the return configuration of the second truck is secured on said first truck second flatbed section..

19. A method for delivering cargo to at least one location, comprising:
sending a first truck with a cargo and a second truck with a cargo to at least one location for delivery to said location, wherein said first stuck has a tractor unit, a first flatbed section attached to said tractor unit, and a second flatbed section attached to said first flatbed section, wherein said second truck has a tractor unit, a first flatbed section attached to said tractor unit, and a second flatbed section attached to said first flatbed section, wherein said first truck has cargo secured to said first truck first flatbed section and said first truck second flatbed section, wherein said second truck has cargo secured to said second truck first flatbed section and said second truck second flatbed section, and wherein said first flatbed section of said first and said second truck each having at least one pair of wheels attached to the bottom surface of each of said first and said second truck first flatbed sections, said second flatbed section of said first and said second truck each having at least one pair of wheels attached to the bottom surface of each of said first and said second truck section flatbed sections, said tractor unit of said first and said second truck each having at least one pair of wheels attached to the bottom surface of said first and said second truck tractor unit for driving said tractor unit, wherein said first truck and said second truck have 2 axles, have flatbed sections of substantially the same size, and have tractor units of substantially the same size;
unloading said cargo from said first truck and said second truck when said first truck and said second truck arrive at said location;
detaching said second truck second flatbed section from said second truck first flatbed section;
securing said second truck second flatbed section onto the top surface of said second truck first flatbed section to form a return configuration for said second truck, said return configuration being said second truck first flatbed section attached to said second truck tractor unit and said second truck second flatbed section secured to said second truck first flatbed section;
securing said return configuration of said second truck onto said second flatbed section of said first truck;
securing a backhaul cargo onto at least a portion of said first flatbed section of said first truck; and
returning said second truck, said backhaul cargo, and said first truck to a final destination for said second truck, to a final destination for said backhaul cargo, and to a final destination for said first truck.
